(19) United States
(12) Patent Application Publication
(10) Pub. No.: US 2012/0226681 A1
(43) Pub. Date: Sep. 6, 2012

(54) FACET DETERMINATION USING QUERY LOGS

(75) Inventors: Stelios Paparizos, Mountain View, CA (US); Panayiotis Tsaparas, San Francisco, CA (US); Jeffrey A. Pound, Ontario (CA)

(73) Assignee: Microsoft Corporation, Redmond, WA (US)

(21) Appl. No.: 13/037,388

(22) Filed: Mar. 1, 2011

(51) Int. Cl. G06F 17/30

(52) U.S. Cl. 707/723; 707/769; 707/E17.014

(57) ABSTRACT

Previously received queries from a search log are analyzed to determine a category of structured data associated with each query. For example, the categories may correspond to consumer product categories such as televisions, digital cameras, etc. For each category, the terms of the queries associated with the category are correlated with the attributes and attribute values of the structured data tuples associated with the category. The attributes may be ranked based on the correlation. When a subsequent query is received, the category of the query is determined and the ranked attributes associated with the category are used to select facets that are displayed to the user along with the search results.

### BACKGROUND

In recent years there has been an increase in the incorporation of results from structured data into results sets generated based on user queries. Structured data are data tuples having a variety of well defined attributes and attribute values and are typically used to represent items such as consumer products, for example. When displaying search results based on structured data, facets are a useful tool to allow users to navigate or refine their search results. Facets typically correspond to attributes of the structured data and are displayed to a user near the search results. The user may then refine the provided results by specifying or selecting attribute values for one or more of the attributes corresponding to the displayed facets.

While facets are useful for allowing a user to refine their own search, determining which facets to display to a user may be difficult. For example, each tuple of structured data may include tens or even hundreds of attributes, and each attribute may have many possible attribute values. Because space to display facets on a search results page is typically limited by the results as well as advertisements, a determination may be made as to which attributes and attribute values to use for the facets that are displayed with the search results.

### SUMMARY

Previously received queries are analyzed to determine a category of structured data associated with each query. For example, the categories may correspond to consumer product categories such as televisions, digital cameras, etc. Categories may also be abstract and may correspond to tables or collections of entities of the same type. For each category, the terms of the previously received queries associated with the category are correlated with the attributes and attribute values of structured data associated with the category. The attributes are ranked based on the correlation. When a subsequent query is received, the category of the query is determined and the ranked attributes associated with the category are used to select facets that are displayed to the user along with search results that are responsive to the query.

In an implementation, queries are received by a computing device. A category is associated with each query by the computing device. Each category corresponds to a set of structured tuples. Each structured data tuple includes attributes, and each attribute has an attribute value. For each query, one or more tokens for the query are determined based on the attribute values of the attributes of the set of structured data tuples corresponding to the category associated with the query. Each token is associated with one or more attributes. For each category, a subset of the attributes from the set of structured data tuples corresponding to the category are ranked based on the tokens associated with the attributes of the set of structured data tuples corresponding to the category.

In an implementation, a query is received at a computing device. A category associated with the received query is determined by the computing device. The category has an associated ranked set of attributes and each attribute has one or more associated attribute values. One or more attributes from the associated ranked set of attributes are selected according to the ranking. One or more attribute values are selected from the attribute value(s) associated with each of the selected one or more attributes. The selected attribute(s) and corresponding selected attribute value(s) are provided as facets by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment using a facet engine;

FIG. 2 is an illustration of an example user interface;

FIG. 3 is an illustration of an example facet engine;

FIG. 4 is an operational flow of an implementation of a method for ranking a subset of attributes;

FIG. 5 is an operational flow of an implementation of a method for providing one or more facets; and

FIG. 6 shows an exemplary computing environment.

### DETAILED DESCRIPTION

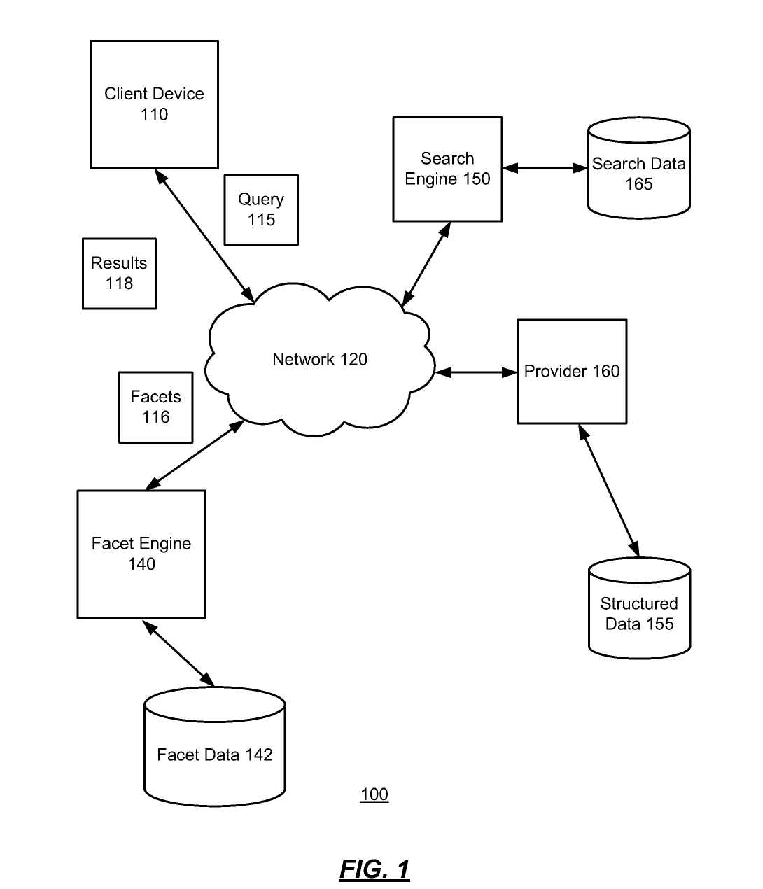

FIG. 1 is an illustration of an example environment 100 using a facet engine 140. The environment 100 may include a client device 110, a search engine 150, a provider 160, and the facet engine 140 in communication with one another through a network 120. The network 120 may be a variety of network types including the public switched telephone network (PSTN), a cellular telephone network, and a packet switched network (e.g., the Internet).

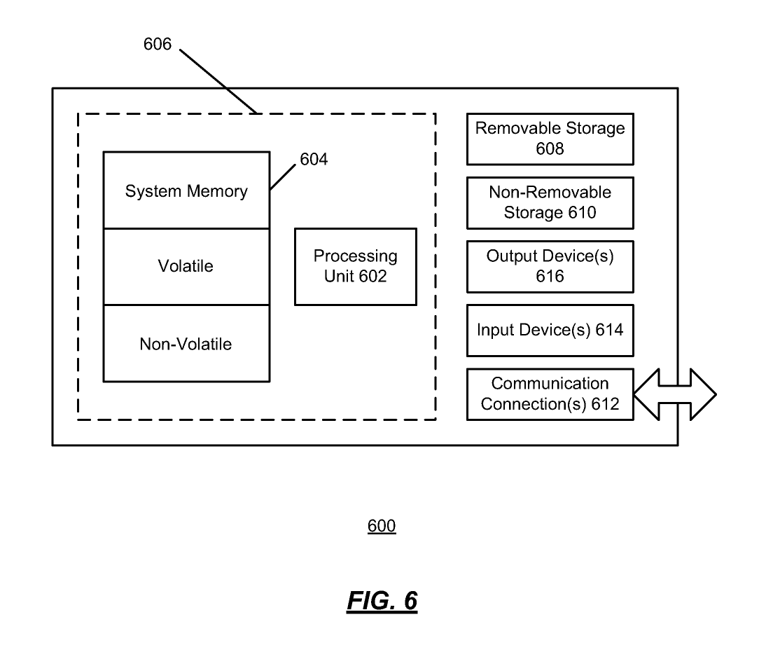

In some implementations, the client device 110 may include a desktop personal computer, workstation, laptop, PDA (personal digital assistant), cell phone, smart phone, or any WAP (wireless application protocol) enabled device or any other computing device capable of interfacing directly or indirectly with the network 120. The client device 110 may be implemented using a general purpose computing device such as the computing device 600 described with respect to FIG. 6, for example. While only one client device 110 is shown, it is for illustrative purposes only; multiple client devices may be supported.

The search engine 150 may be configured to receive a query 115 or queries from each user of a client device 110. The search engine 150 may search for media responsive to a query 115 by searching a search corpus using the received query 115. The search engine 150 may return a set of results 118 to the client device 110 including links to some or all of the media that is responsive to the query 115.

In some implementations, the search engine 150 may store some or all of the queries that it receives as search data 165. Each query 115 may include several terms. For example, the query “Sony Television” may include the term Sony and the term television. In some implementations, each query 115 may further be characterized by genre or category. For example, the above described query may be of the category “electronics”, or even more specifically “television”. The categories may be automatically determined or may be manually determined. In some implementations, each category may correspond to a category of consumer products (e.g., televisions, digital cameras, shoes, and clothing).

The provider 160 may be configured to provide results 118 responsive to requests or queries received directly from users using one or more client devices, or indirectly from the search engine 150. For example, one or more webpages available from the provider 160 may be indexed by the search engine 150 as part of the search corpus. The provider 160 may also allow users to search for, view, and purchase a variety of products or services through one or more webpages associated with the products and services. For example, the provider 160 may be associated with an electronics retailer and users may browse and search for electronics available for sale by providing a query 115 or queries to the provider 160. The provider 160 may then return results 118 including a set of links to webpages associated with products available from the provider 160 that are responsive to the provided query 115.

The provider 160 may store some or all of the data for its available products and services as structured data 155. The structured data 155 may include a plurality of structured data tuples. Each structured data tuple may include a plurality of attributes, and each attribute may take on one or more attribute values. For example, structured data tuples may be used to represent the television inventory of an electronics retailer. Typical attributes associated with the televisions may include “brand”, “type”, “size”, “price”, etc. Further, each television may have one or more attribute values associated with one or more of the attributes. Because every attribute may not be applicable to each television, each attribute may not have a corresponding attribute value for each product. Each structured data tuple may correspond to a row of a table. However other data structures may be used. An example table of structured data tuples for four televisions is shown as Table 1:

TABLE 1

| Television ID | TYPE | BRAND | SIZES | PRICE |
|---|---|---|---|---|
| 1 | LCD | SONY | 46 inch | $700 |
| 2 | PLASMA | SAMSUNG | 42 inch | $500 |
| 3 | LCD | SAMSUNG | 32 inch | $300 |
| 4 | PLASMA | SONY | 50 inch | $999 |

In some implementations, the structured data 155 may comprise multiple sets or tables with each table corresponding to a particular genre or category of products or services. For example, the structured data 155 may include a table of structured data tuples associated with televisions, a table of structured data tuples associated with digital cameras, and a table of structured data tuples associated with refrigerators. When a query 115 is received, the provider 160 may determine the category corresponding to the query 115, and may fulfill the received query using the corresponding table of structured data. The categories may correspond to the query categories determined by the search engine 150, for example.

In some implementations, the search engine 150 may also store and maintain structured data 155. The structured data 155 maintained by the search engine 150 may be provided to the search engine 150 from one provider 160 or more than one provider. The search engine 150 may then fulfill one or more queries using the structured data 155.

The facet engine 140 may receive a query 115, and based on the category associated with the query, provide one or more facets 116 corresponding to the received query 115. The facet engine 140 may receive the query 115 directly from a client device 110, or indirectly from the search engine 150 and/or the provider 160. The facet engine 140 may provide the facets 116 directly to the client device 110, or may provide the facets 116 to the search engine 150 and/or the provider 160, who may then provide the facets 116 to the client device 110 along with the results 118. While the facet engine 140 is illustrated as separate from the search engine 150 and the provider 160, it is contemplated that the facet engine 140 may be implemented as a component of either the search engine 150 or the provider 160. The facet engine 140 may be implemented using a general purpose computing device such as the computing device 600 described with respect to FIG. 6, for example.

Each of the facets 116 may include a heading corresponding to an attribute, and may have one or more attribute values associated with the attribute available for selection (e.g., by the user) underneath the heading. A user may interact with the displayed facets 116 by selecting or deselecting one or more of the attribute values displayed for each attribute heading. Any results 118 displayed along with the facets 116 may be revised by the search engine 150 and/or the provider 160 based on the attribute values selected. Thus, a user may expand or contract the scope of their original query 115 by interacting with the facets 116. The attribute(s) and attribute value(s) corresponding to each facet 116 may be selected by the facet engine 140 based on the attribute(s) and attribute value(s) of the structured data 155 corresponding to a category of a received query 115.

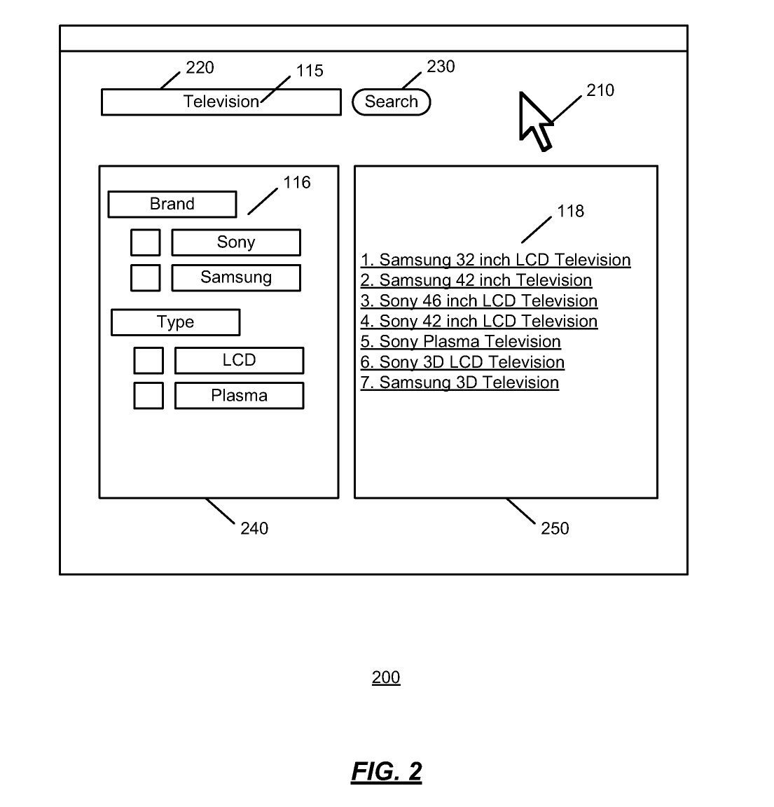

FIG. 2 is an illustration of an example user interface 200 that includes facets. The user interface 200 may correspond to a set of results 118 generated by a search engine 150 and/or a provider 160. For example, a user of the client device 110 may have provided an initial query 115 to the provider 160 by entering terms of the query 115 into a search box 220 and submitting the query 115 to the provider 160 by selecting a search button 230 using a pointer 210. As illustrated, the user has provided the query 115 “Television”.

In response to the query 115, the provider 160 has generated a set of results 118. The results 118 are shown in a portion 250 of the user interface 200. The results 118 comprise links to products having associated structured data that matches or partially matches the query 115. The user may view a product corresponding to a link by selecting the link using the pointer 210. Some of the links shown in the portion 250 may correspond to television products from Table 1, for example.

In addition, the facet engine 140 has provided a set of facets 116 that are displayed in a portion 240 of the user interface 200. As illustrated, each of the facets 116 has a heading that corresponds to an attribute of the structured data 155 that corresponds to the category associated with the query 115, followed by one or more attribute values that correspond to the attribute of each heading. The heading “Brand” corresponds to the attribute “brand” from Table 1, and is followed by the attribute values “Sony” and “Samsung”. Similarly, the heading “Type” corresponds to the attribute “type” and is followed by the attribute values “LCD” and “Plasma”.

The user may refine the query 115 in the search box 220 by selecting or checking the boxes proximate to the attribute values of each of the facets 116. Any selected attribute values may be added to the query 115, and the results 118 in the portion 250 may be updated using the new query. For example, if the user checked the box in front of the attribute value “LCD” using the pointer 210, the query 115 may be updated to “LCD Television” and the results 118 in the portion 250 may be updated to include links to products that match the revised query.

As can be appreciated, the facets 116 provide a powerful way for the user to further refine their query 115 by selecting or deselecting attribute values for attributes from the structured data 155. However, a structured data tuple may include tens or hundreds of attributes, and the amount of space in the portion 240 reserved for displaying facets 116 is limited. Thus, the facet engine 140 may select which attribute(s) and/or attribute value(s) are used for the facets 116.

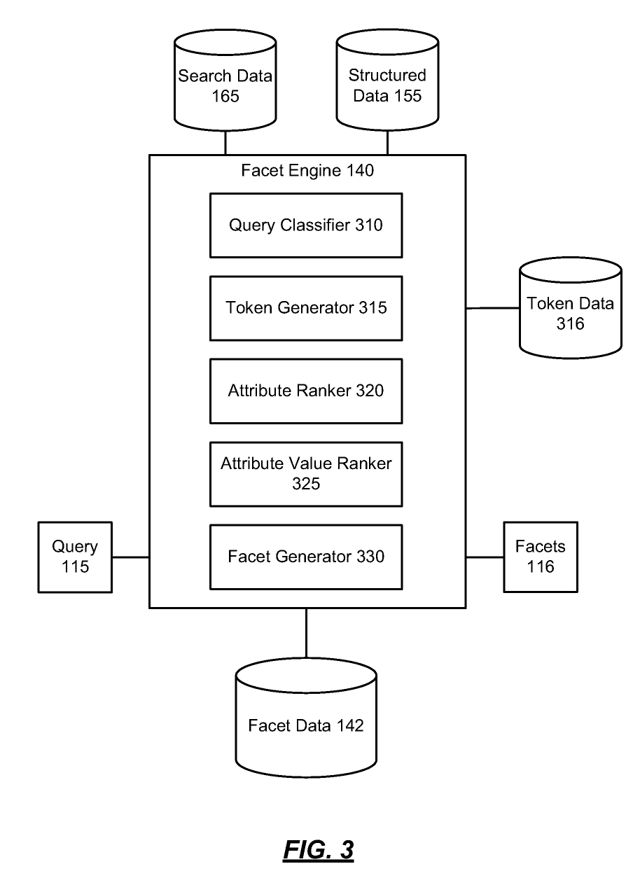

In some implementations, the facet engine 140 may select the attributes and attribute values based on facet data 142. As described further with respect to FIG. 3, the facet data 142 may include a ranking of attributes for each query category. The facet engine 140 may select facets 116 based on a category of a received query 115 by selecting attributes according to the attribute ranking for the category as indicated by the facet data 142. The ranking of attributes for each category may be determined in part by the facet engine 140 based on the terms of previously received queries from the search data 165, for example.

FIG. 3 is an illustration of an example facet engine 140. As illustrated, the facet engine 140 includes several components including, but not limited to, a query classifier 310, a token generator 315, an attribute ranker 320, an attribute value ranker 325, and a facet generator 330. More or fewer components may be supported by the facet engine 140.

The query classifier 310 may classify some or all of the queries in the search data 165 into one of a group of categories. The categories may correspond to one or more categories associated with tables or sets of structured data from the structured data 155. For example, the categories may correspond to types of consumer products. In some implementations, the category that a query 115 is classified into may be determined by one or more terms associated with the query 115. For example, a query 115 having the term “television” may be classified into a category associated with televisions. Other known methods and techniques for classifying a query 115 into a category may be used by the query classifier 310.

The token generator 315 may determine token data 316 based on the queries from the search data 165. In some implementations, a token may be a string that is generated from the terms of a query 115 and may be generated based on the attribute values of the attributes of the structured data 155 that are associated with the category assigned to the query 115. For example, where the category associated with the query 115 is digital cameras, the token generator 315 may parse the query 115 looking for terms that match or are partial matches of attribute values associated with digital cameras such as “megapixels”, “zoom”, etc. The attribute values may be taken from the tuples of the structured data 155 corresponding to the category assigned to the query 115. In addition, known synonyms or misspellings of the attribute values may also be used to generate tokens. Each token may be associated with the attribute corresponding to the matched attribute value to form a token and attribute pair and stored as part of the token data 316.

Because some attribute values may be ambiguous or associated with more than one attribute, some of the determined tokens may also be associated with more than one attribute. For example, the term “20 inch” of the query “20 inch television” may match an attribute value of an attribute corresponding to the width of a television, an attribute value of an attribute corresponding to the height of a television, and an attribute value of an attribute corresponding to the diagonal length of a television. Where a token is associated with multiple attributes, a token and attribute pair for each token and attribute combination may be stored in the token data 316. A token that is associated with more than one attribute for a category is known as an ambiguous token.

The attribute ranker 320 may rank the attributes for each of the categories based on the tokens associated with each attribute of each category. In an implementation, the attribute ranker 320 may rank the attributes for each category based on the frequency with which each attribute is associated with a token in the token data 316 for that category. The attributes may be ranked for a category based on the token association frequencies and stored as the facet data 142. The ranking of the attributes may then be used by the facet generator 330 to select the attributes to provide as part of one or more facets 116.

In some implementations, where a token is an ambiguous token, the attribute ranker 320 may perform attribute disambiguation and disassociate the token from the least probable attributes. One method for attribute disambiguation is referred to as token-level disambiguation.

For token-level disambiguation, the attribute ranker 320 may consider each token independently and may determine which attribute has the highest probability of being correctly associated with a token. The attribute ranker 320 may associate each ambiguous token with the attribute with the highest determined probability. In some implementations, the attribute ranker 320 may calculate the probability P_{T} that an attribute Aᵢ is associated with a token t using equation (1), where Aᵢ is the i^{th} attribute associated with the token t, |T(A,t)| is the number of structured data tuples associated with the category of the token from the structured data 155 where the attribute A has an attribute value that is equivalent to t, and |A| is the total number of attributes A in the set of structured data tuples associated with the category:

$${P}_{T} ( t \vert {A}_{i} ) = \frac{\vert T ( A , t ) \vert}{\vert A \vert} \qquad ( 1 )$$

In another implementation, the attribute ranker 320 may perform attribute disambiguation using what is referred to as attribute-level disambiguation. For attribute-level disambiguation, the attribute ranker 320 may aggregate the token and attribute pairs to identify clusters of ambiguous attribute token pairs. The attribute ranker 320 may then select attributes to associate with the tokens based on distribution of the tokens over all of the clusters.

In some implementations, the attribute ranker 320 may construct a graph for the set of structured data corresponding to each category. The graph may include a vertex for each attribute in the set and an edge between each vertex that represents an attribute that is associated with the same token. Each edge may further include a weight that represents the number of tokens that are associated with both attributes corresponding to the vertices.

The attribute ranker 320 may then identify clusters of ambiguous attributes by identifying vertices that are connected to one another with edges having equal weights. In some implementations, the attribute ranker 320 may only consider edge weights that are greater than a specified threshold.

After identifying the clusters of ambiguous attributes, the attribute ranker 320 may select an attribute for each cluster that is most likely to model the set of ambiguous tokens associated with the cluster. In some implementations, the attribute ranker 320 may select an attribute using equation (2), where KL represents the Kullback-Leibler divergence, C is the cluster of attributes and Aᵢ is an attribute in the cluster:

$$P ( A \vert C ) = \frac{KL ( A \vert \vert C )}{{\sum }_{{A}_{i} ∈ C} KL ( {A}_{i} \vert \vert C )} \qquad ( 2 )$$

The attribute ranker 320 may then disambiguate a token by associating the attribute of the cluster with the highest calculated probability with the token corresponding to the cluster.

In another implementation, the attribute ranker 320 may perform attribute disambiguation using what is referred to as query-log-level disambiguation. For query-log-level disambiguation, the attribute ranker 320 may estimate the probability P(A|t) for an ambiguous token t such that the likelihood of each query 115 from the search data 165 is maximized.

In some implementations, the attribute ranker 320 may assign a weight w to each token based on the number of queries from the search data 165 that the query appears in. The probability of each token t being generated is given by the equation (3), where Aᵢ is a attribute associated with the token t:

P(t)=ΣP(t|Aᵢ)×P(Aᵢ) (3)

The attribute ranker 320 may then minimize the following formula:

Σwₜ×log(P(t)) (4)

In some implementations, the minimization may be performed by the attribute ranker 320 using an iterative expectation maximization algorithm. The attribute Aᵢ having the highest generated probability for each ambiguous token t may be selected by the attribute ranker 320.

In some implementations, the attribute ranker 320 may perform attribute disambiguation using what is referred to as click-based disambiguation. For click-based disambiguation, the attribute ranker 320 may attempt to determine the intent of the user that provided the query 115 that the ambiguous token was generated from. The attribute ranker 320 may the select the attribute that best matches the intent of the user. One such measure of intent is the link that a user selected or clicked on immediately after submitting the query. For example, if a user provided the query 115 “42 inch television” and then selected a link to a television having a diagonal measurement of 42 inches, the intent of the query 115 can be inferred to be towards a television with a 42 inch diagonal length rather than a television with a 42 inch height or a 42 inch length. Other well known indications of user intent may also be considered such as query reformulation, for example. The indications of user intent may be stored as part of the search data 165.

In some implementations, the attribute ranker 320 may remove attributes from consideration for facet inclusion that have an entropy that is below a threshold entropy. The entropy of an attribute is determined based on a distribution of distinct values for the attribute given the frequency of the values. A preference can be given to attributes that have associated values that are equally or uniformly distributed versus attributes that have a skewed distribution of attribute values where a few values dominate the attribute space. For example, an attribute from the structured data 155 that has the same attribute value for every structured data tuple may have an entropy of zero. Providing a facet that includes such an attribute would not be helpful to a user because the user would only have one attribute value to select from. The attribute ranker 320 may calculate the entropy for each attribute and remove attributes from consideration that have calculated entropies that are below a threshold entropy. The threshold entropy may be determined by a user or administrator, for example.

In some implementations, the attribute ranker 320 may remove attributes from consideration that are sparse. An attribute is sparse if it does not have an associated attribute value for a threshold number of structured data tuples of the structured data 155 for a particular category. Attributes that are sparse are more likely to have incomplete or noisy attribute values than non-sparse attributes, and may therefore lead to a poor search experience for the user.

The attribute value ranker 325 may rank the attribute values for each attribute for each category. In some implementations, the attribute value ranker 325 may rank the attribute values using what is referred to as static ranking. For static ranking, the attribute values may be ranked with respect to each attribute based on the frequency with which they appear in the structured data 155 for that attribute. For example, if the attribute value of “42 inch” appears in structured tuples for the attribute “size” more than the attribute value “20 inch”, then the attribute value “42 inch” may be ranked higher than the attribute value “20 inch”. The ranking associated with the attribute values may be stored by the attribute value ranker 325 as part of the facet data 142.

In some implementations, rather than rank the attribute values, the attribute value ranker 325 may generate probabilities for the attribute values that may be used by the facet generator 330 to rank and select the attribute values as part of what is referred to herein as dynamic ranking. In dynamic ranking, the attribute values that are selected for an attribute of a facet are dynamically ranked based on the terms of a received query. To facilitate the dynamic ranking, the attribute value ranker 325 may generate a pairwise probability for each unique pair of attribute values based on the number of times that the attribute values appear together in the queries of the query data 165 for a particular category. The pairwise probabilities may then be used to rank attribute values based on the terms that appear in a received query. Attribute values that have a high pairwise probability with respect to some or all of the terms of a received query 115 for a category may be ranked higher than attribute values that have a low pairwise probability with respect to some or all of the terms of the received query for the same category. The generated pairwise probabilities may be stored as part of the facet data 142.

The facet generator 330 may provide one of more facets 116 in response to a query 115. In some implementations, the facet generator 330 may select one or more attributes for each facet based on the category associated with the query as determined by the query classifier 310. The facet generator 330 may select the highest ranked attributes for the category from the facet data 142. The number of attributes selected by the facet generator 330 may be dependent on the number of facets 116 that can be displayed along with the results 118. Each selected attribute may be used as a heading for a facet by the facet generator 330.

The facet generator 330 may select one or more attribute values for each attribute selected for a facet. Each selected attribute value may be displayed as a selection underneath a heading of a facet. Where static ranking was used to rank the attribute values by the attribute ranker 325, the facet generator 330 may select the highest ranked attribute values for each selected attribute. Where dynamic ranking was used by the attribute ranker 325 to calculate the pairwise probabilities for attribute values, the facet generator 330 may select the attribute values for the selected attributes that have the highest calculated pairwise probabilities with respect to the terms of the received query 115. The number of attribute values selected for each attribute may be dependent on the amount of space available for each facet and/or specified by a user or administrator, for example.

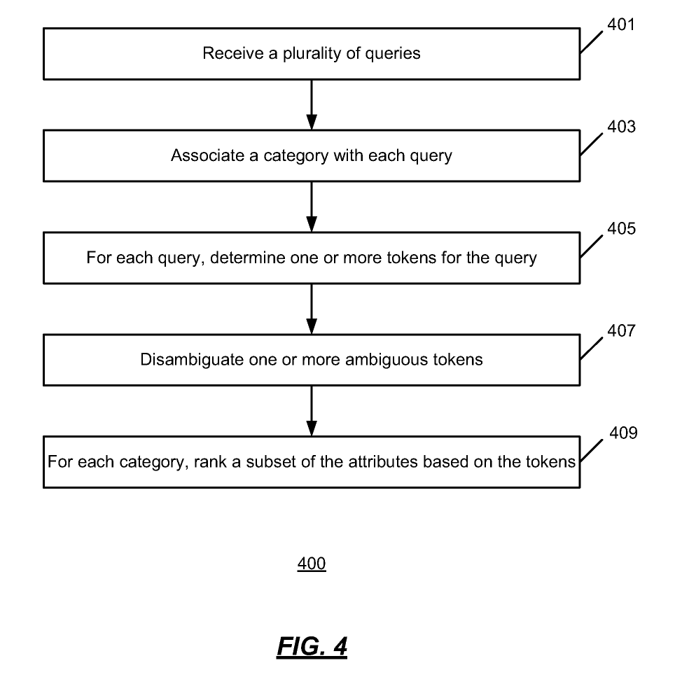

FIG. 4 is an operational flow of an implementation of a method 400 for ranking a subset of attributes for one or more categories. The ranked attributes for a category may be used to provide one or more facets 116 for a received query 115 associated with the category. The method 400 may be implemented by the facet engine 140, for example.

A plurality of queries is received at 401. The queries may be received by the facet engine 140. The plurality of queries may be part of the search data 165 and may be a query log of some or all of the queries received by a search engine 150 and/or provider 160 during a specified time period. Each query 115 may each be weighted by a frequency that represents the number of times that the query was received.

A category is associated with each query at 403. A category may be associated with each query of the plurality of queries by the query classifier 310 of the facet engine 140. Each category may correspond to a subset of structured data tuples or a unique table of the structured data 155. Each category may be associated with a consumer product such as televisions, for example. In some implementations, a category may be associated with each query 115 by parsing the terms of the query 115 to determine the intent of the user who submitted the original query 115. Any known method for determining the intent of a query 115 may be used. The determined category may then be associated with the query 115 by the query classifier 310.

For each query, one or more tokens are determined for the query at 405. The tokens may be determined by the token generator 315 of the facet engine 140. The tokens may be determined for a query 115 by parsing the terms of the query to determine terms that match, or are partial matches, of the attribute values of attributes of the table of structured data corresponding to the category of the query. The determined tokens are associated with the attributes corresponding to the matching attribute values. In some implementations, known synonyms and/or misspellings of the attribute values may also be used to determine the one or more tokens.

One or more ambiguous tokens are disambiguated at 407. The one or more ambiguous token may be disambiguated by the attribute ranker 320 of the facet engine 140. A token is ambiguous if the token was determined to match attribute values associated with different attributes, and is therefore associated with more than one attribute. In some implementations, the attribute ranker 320 may disambiguate an attribute by determining which attribute likely represents the true intent of the token. In other words, which attribute did a user most likely have in mind when they provided the term of the query 115 that the token was determined from. The attributes other than the most likely attribute may be discarded or disassociated from a token by the attribute ranker 320. The attribute ranker 320 may disambiguate the tokens using one or a combination of token-level disambiguation, attribute-level disambiguation, query-log-level disambiguation, and clicks-based disambiguation, for example.

For each category, attributes from a subset of the attributes are ranked based on the tokens at 409. The subset of attributes may be ranked by the attribute ranker 320 of the facet engine 140. The subset of attributes may be ranked for each category by counting the number of tokens associated with each attribute in the subset and ranking the attributes based on the number of tokens associated with each attribute. The ranking of attributes for each category may be stored by the attribute ranker 320 as part of the facet data 142. The ranking of attributes may be used by the facet generator 330 to select attributes to provide as facets 116 based on a category associated with a received query 115, for example.

In some implementations, the attribute ranker 320 may further remove attributes from the subset of attributes for each category that have an entropy that is lower than a threshold entropy. Alternatively or additionally, the attribute ranker 320 may further remove sparse attributes from the subset of attributes for each category.

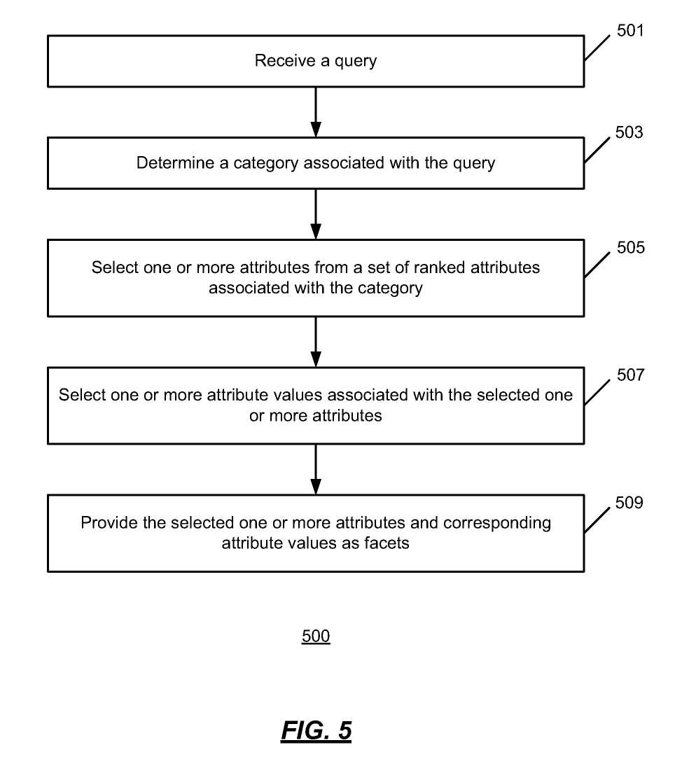

FIG. 5 is an operational flow of an implementation of a method 500 for providing one or more facets. The method 500 may be implemented by the facet engine 140, for example.

A query is received at 501. The query, such as the query 115, may be received by the facet engine 140. The query 115 may be received directly from a user of a client device 110, or indirectly from one of a search engine 150 and/or a provider 160. For example, a user of the client device 110 may have generated a query 115 and submitted it to a search engine 150. The search engine 150 may have generated a set of results 118 in response to the query 115, and provided the query 115 to the facet engine 140 to provide a set of facets 116 to include with the results 118.

A category associated with the query is determined at 503. The category may be determined by the query classifier 310 of the facet engine 140. In an implementation, the category may correspond to a category of consumer products and may be associated with a set or table of structured data tuples from the structured data 155.

One or more attributes from a set of ranked attributes associated with the category are selected at 505. The one or more attributes may be selected by the facet generator 330 from the facet data 142. The facet data 142 may include a ranked list of attributes for each category. The facet generator 330 may select attributes from the set of ranked attributes in ranked order. The number of attributes selected by the facet generator 330 may depend on the amount of facets 116 desired, for example

One or more attribute values associated with the selected one or more attributes are selected at 507. The one or more attribute values may be selected by the facet generator 330 of the facet engine 140. Where the attribute values were statically ranked, the facet generator 330 may select attributes values associated with each of the selected attributes based on a ranked list of attribute values for each attribute. The ranked list of attribute values for each attribute may have been generated by the attribute value ranker 325 and may be stored as part of the facet data 142.

Where the attribute values were dynamically ranked, the facet generator 330 may select one or more attribute values based on the terms of the query 115 and the calculated pairwise probabilities for each unique pair of terms from the queries in the search data 165. The facet generator 330 may then select the attribute values that have the highest pairwise probabilities with respect to the terms of the received query 115.

The selected one or more attributes and corresponding one or more attribute values are provided as facets at 509. The facets 116 may be provided by the facet generator 330 of the facet engine 140 to the client device 110 that provided the initial query 115. Alternatively, the facets 116 may be provided to the search engine 150 or provider 160, and the facets 116 may be provided to the client device 110 along with the results 118.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by computing device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a plurality of queries by a computing device;
associating a category from a plurality of categories with each query by the computing device, wherein each category corresponds to a set of structured tuples and each structured data tuple comprises a plurality of attributes and each attribute has an attribute value;
for each query, determining one or more tokens for the query based on the attribute values of the attributes of the set of structured data tuples corresponding to the category associated with the query by the computing device, wherein each token is associated with one or more attributes; and
for each category, ranking a subset of the attributes from the set of structured data tuples corresponding to the category based on the tokens associated with the attributes of the set of structured data tuples corresponding to the category by the computing device.

2. The method of claim 1, further comprising, for each category, ranking the attribute values associated with each attribute from the set of structured data tuples corresponding to the category.

3. The method of claim 1, wherein the plurality of queries comprises a query log.

4. The method of claim 1, further comprising:
for each category, determining attributes from the ranked subset of attributes corresponding to the category that have an entropy that is below a threshold, and removing attributes from the ranked subset of attributes corresponding to the category that have an entropy that is below the threshold.

5. The method of claim 1, further comprising:
for each category, determining attributes from the ranked subset of attributes corresponding to the category that are sparse attributes, and removing attributes from the ranked subset of attributes corresponding to the category that are sparse attributes.

6. The method of claim 1, further comprising:
receiving a query;
determining a category associated with the received query;
selecting one or more attributes from the ranked subset of attributes corresponding to the determined category; and
providing the selected one or more attributes as facets.

7. The method of claim 6, further comprising:
selecting one or more attribute values associated with the selected one or more attributes; and
providing the selected one or more attributes values with the facets.

8. The method of claim 7, further comprising ranking the attribute values associated with each attribute, and selecting the one or more attribute values according to the ranking.

9. The method of claim 8, wherein the attribute values are ranked based on one or more terms associated with the received query.

10. The method of claim 1, wherein the attributes in the subset of attributes are ranked based on the number of tokens associated with each attribute.

11. The method of claim 1, further comprising:
determining tokens that are associated with more than one attribute; and
disambiguating the determined tokens.

12. A method comprising:
receiving a query at a computing device;
determining a category associated with the received query by the computing device, wherein the category has an associated set of attributes and each attribute has one or more associated attribute values;
selecting one or more attributes from the associated set of attributes by the computing device;
selecting one or more attribute values from the one or more attribute values associated with each of the selected one or more attributes by the computing device; and
providing the selected one or more attributes and corresponding selected one or more attribute values as facets by the computing device.

13. The method of claim 12, wherein the set of attributes is a ranked set of attributes, and selecting one or more attributes from the associated set of attributes comprises selecting one or more attributes according to the ranking.

14. The method of claim 12, further comprising ranking the one or more attribute values, and selecting the one or more attribute values according to the ranking.

15. The method of claim 14, wherein the one or more attribute values are ranked based on one or more terms associated with the received query.

16. A system comprising:
at least one computing device; and
a facet engine adapted to:
receive a plurality of queries;
associate a category from a plurality of categories with each query, wherein each category corresponds to a set of structured tuples and each structured data tuple comprises a plurality of attributes and each attribute has an attribute value;
for each query, determine one or more tokens for the query based on the attribute values of the attributes of the set of structured data tuples corresponding to the category associated with the query, wherein each token is associated with one or more attributes; and
for each category, rank a subset of the attributes from the set of structured data tuples corresponding to the category based on the tokens associated with the attributes of the set of structured data tuples corresponding to the category.

17. The system of claim 16, wherein the facet engine is further adapted to:
for each category, determine attributes from the ranked subset of attributes corresponding to the category that have an entropy that is below a threshold, and remove attributes from the ranked subset of attributes corresponding to the category that have an entropy that is below the threshold.

18. The system of claim 16, wherein the facet engine is further adapted to:
for each category, determine attributes from the ranked subset of attributes corresponding to the category that are sparse attributes, and remove attributes from the ranked subset of attributes corresponding to the category that are sparse attributes.

19. The system of claim 16, wherein the facet engine is further adapted to:
receive a query;
determine a category associated with the received query;
select one or more attributes from the ranked subset of attributes corresponding to the determined category; and
provide the selected one or more attributes as facets.

20. The system of claim 16, wherein the plurality of queries comprises a query log.
